(19) United States
(12) Patent Application Publication
(10) Pub. No.: US 2019/0121573 A1
(43) Pub. Date: Apr. 25, 2019

(54) STORAGE SYSTEM AND STORAGE CONTROL APPARATUS

(71) Applicant: FUJITSU LIMITED, Kawasaki-shi (JP)

(72) Inventor: Naoki Kobayashi, Setagaya (JP)

(73) Assignee: FUJITSU LIMITED, Kawasaki-shi (JP)

(21) Appl. No.: 16/142,056

(22) Filed: Sep. 26, 2018

(30) Foreign Application Priority Data
Oct. 19, 2017 (JP) 2017-202515

(51) Int. Cl. G06F 3/06

(52) U.S. Cl. CPC G06F 3/0655; G06F 3/0613; G06F 3/0683

(57) ABSTRACT

A storage system includes a storage device, and a plurality of storage control devices configured to couple to each other through a plurality of communication routes, a first storage control device of the plurality of storage control devices configured to include a memory, and a processor coupled to the memory and the processor configured to generate route blocking information based on detection of a blocking state of a communication route of the plurality of communication routes, generate detour route information set for a destination storage control device of the plurality of storage control devices, which becomes a communication destination, based on the route blocking information, store the route blocking information and the detour route information in the memory, and perform a detour communication through a detour route selected based on the detour route information when performing communication to the destination storage control device so as to control the storage device.

### CROSS-REFERENCE TO RELATED APPLICATION

This application is based upon and claims the benefit of priority of the prior Japanese Patent Application No. 2017-202515, filed on Oct. 19, 2017, the entire contents of which are incorporated herein by reference.

### FIELD

The embodiments discussed herein are related to a storage system, a storage control apparatus, and a program.

### BACKGROUND

A storage system includes a storage device such as a hard disk drive (HDD) or a solid state drive (SSD) and a server for controlling the storage device, and records and manages a large amount of data handled by information processing. In addition, the server usually has a redundant configuration including two or more nodes.

Meanwhile, when enhancing system performance, in recent years, a scale-out which increases a processing capacity by increasing the number of hardware is becoming mainstream, instead of a scale-up which makes the hardware to have a high performance. For this reason, the redundant configuration of the system has increased with an expansion of the system by the scale-out.

In a server designed with the scale-out of a multi-node configuration, when communication routes between nodes are blocked due to, for example, an occurrence of a failure, the system operation may be continued by performing a detour communication via a detour route.

Related techniques are disclosed in, for example, Japanese Laid-open Patent Publication Nos. 09-252331, 05-003475, and 2006-333486.

### SUMMARY

According to an aspect of the invention, a storage system includes a storage device, and a plurality of storage control devices configured to couple to each other through a plurality of communication routes, a first storage control device of the plurality of storage control devices configured to include a memory, and a processor coupled to the memory and the processor configured to generate route blocking information based on detection of a blocking state of a communication route of the plurality of communication routes, generate detour route information set for a destination storage control device of the plurality of storage control devices, which becomes a communication destination, based on the route blocking information, store the route blocking information and the detour route information in the memory, and perform a detour communication through a detour route selected based on the detour route information when performing communication to the destination storage control device so as to control the storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a storage system;

FIG. 2 is a diagram illustrating an example of the configuration of the storage system;

FIG. 3 is a diagram illustrating an example of the configuration of the storage system;

FIG. 4 is a diagram illustrating an example of an internal configuration of a node;

FIG. 5 is a diagram illustrating an example of a direct memory access (DMA) transmission;

FIG. 6 is a diagram illustrating an example of a DMA transmission by a detour communication;

FIG. 7 is a diagram illustrating an example of a state in which the execution of the detour communication is not available;

FIG. 8 is a diagram illustrating an example of a state in which the load is concentrated on a specific node during the detour communication;

FIG. 9 is a diagram illustrating an example of a hardware configuration of a node;

FIG. 10 is a diagram illustrating an example of a functional block of the node;

FIG. 11 is a flowchart illustrating an operation from the generation of a blocked route until the detour communication is executed;

FIG. 12 is a diagram illustrating an example of a table configuration of monitoring information;

FIG. 13 is a diagram illustrating an example of a management of the blocked route in each node;

FIG. 14 is a diagram illustrating an example of a management of host bus adapter (HBA) failure information in each node;

FIG. 15 is a diagram illustrating an example of a detour list;

FIG. 16 is a diagram for describing an example of a detection of the monitoring information and a transmission of the monitoring information to another node;

FIG. 17 is a flowchart illustrating an operation of a receiving process of the monitoring information;

FIG. 18 is a flowchart illustrating an operation of an updating process of the detour list;

FIG. 19 is a flowchart illustrating an operation of a detour communication process;

FIG. 20 is a diagram for describing an example of an operation of the detour communication; and

FIG. 21 is a diagram for describing an example of the operation of the detour communication.

### DESCRIPTION OF EMBODIMENTS

In a case where the detour communication is performed, a node that detects a blocking of a communication route refers to routing information between the nodes with respect to another node and activates a search of a detour route based on the routing information. However, with such control, it takes time to set the detour route and a processing load also increases, so that it is difficult to perform an efficient detour communication.

Hereinafter, an aspect of technology that makes it possible to improve the efficiency of the detour communication will be described with reference to the drawings.

### First Embodiment

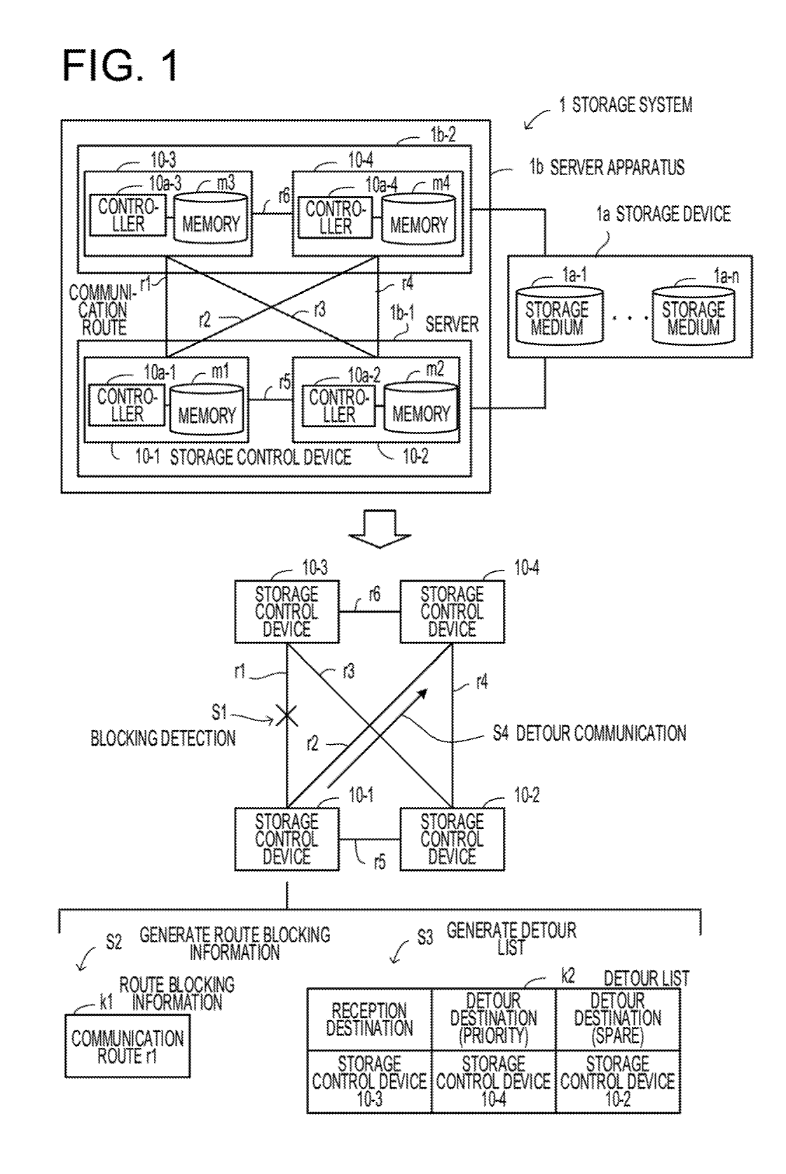

A first embodiment will be described with reference to FIG. 1. FIG. 1 is a diagram illustrating an example of the configuration of the storage system. A storage system 1 includes a storage device 1a and a server device 1b.

The storage device 1a includes storage media 1a-1, . . . , and 1a-n including, for example, HDD (Hard Disk Drive) and SSD (Solid State Drive). The server device 1b includes servers 1b-1 and 1b-2. The server 1b-1 includes storage control devices 10-1 and 10-2, and the server 1b-2 includes storage control devices 10-3 and 10-4.

The storage control devices 10-1 to 10-4 are connected to communication routes r1 to r6, perform a communication between the devices via the communication routes r1 to r6, and perform, for example, an IO control for the storage device 1a.

Further, the storage control devices 10-1 and 10-3 are connected to the communication route r1, and the storage control devices 10-1 and 10-4 are connected to the communication route r2. In addition, the storage control devices 10-2 and 10-3 are connected to the communication route r3, and the storage control devices 10-2 and 10-4 are connected to the communication route r4.

Further, the storage control devices 10-1 and 10-2 are connected to the communication route r5, and the storage control devices 10-3 and 10-4 are connected to the communication route r6. The storage control devices 10-1 to 10-4 control the storage device 1a and include controllers 10a-1 to 10a-4 and memories m1 to m4, respectively.

The controllers 10a-1 to 10a-4 generate route blocking information based on the detection of the blocked state of the communication route and generate detour route information set for each storage control device which becomes a communication destination, based on the route blocking information. In addition, the controllers 10a-1 to 10a-4 store the route blocking information and the detour route information in the memories m1 to m4 and when performing communication to another storage control device, the controllers 10a-1 to 10a-4 perform a detour communication to the detour route selected based on the detour route information.

An operation will be described using the example illustrated in FIG. 1.

(Operation S1) It is assumed that the communication route r1 is blocked. The controller 10a-1 in the storage control device 10-1 detects the blocked state of the communication route r1.

(Operation S2) The controller 10a-1 generates route blocking information k1 indicating that the communication route r1 is in the blocked state. Further, the route blocking information k1 is propagated to the storage control devices 10-2, 10-3, and 10-4 via the opened communication route and is shared by the respective devices.

(Operation S3) Based on the route blocking information k1, the controller 10a-1 generates a detour list k2 (detour route information) in which a detour destination is set for each reception destination. The detour list k2 has items such as “reception destination 1” and “detour destination,” and for example, when the “reception destination” is the storage control device 10-3, the storage control devices 10-2 and 10-4 are set in the “detour destination.”

(Operation S4) The controller 10a-1 selects the detour destination using the detour list k2 to perform the detour communication. Further, a priority is set in the “detour destination”, and in this example, the “detour destination (priority)” is the storage control device 10-4 and the “detour destination (spare)” is the storage control device 10-2.

Therefore, the controller 10a-1 preferentially selects the storage control device 10-4 as the detour destination and performs detour communication of predetermined data to the storage control device 10-4 via the communication route r2. Upon receiving the predetermined data transmitted from the storage control device 10-1, the storage control device 10-4 transmits the predetermined data to the storage control device 10-3 via the communication route r6.

As described above, the storage system 1 detects the blocked state of the communication route between the storage control devices to generate the route blocking information, generates the detour list in which the detour destination is set for each destination based on the route blocking information, and performs the detour communication by selecting the detour destination by using the detour list.

As a result, the storage system 1 refers to the routing information between the devices with respect to another device when the communication route is blocked, and the controlling of a flow of activating the search of the 3o detour route becomes unnecessary based on routing information. As a result, the storage system 1 may shorten a set time of the detour route or reduce the processing load, and may improve the efficiency of the detour communication.

### Second Embodiment

Next, a second embodiment will be described. First, a system configuration will be described. Further, in the following description, the storage control device is also referred to as a node.

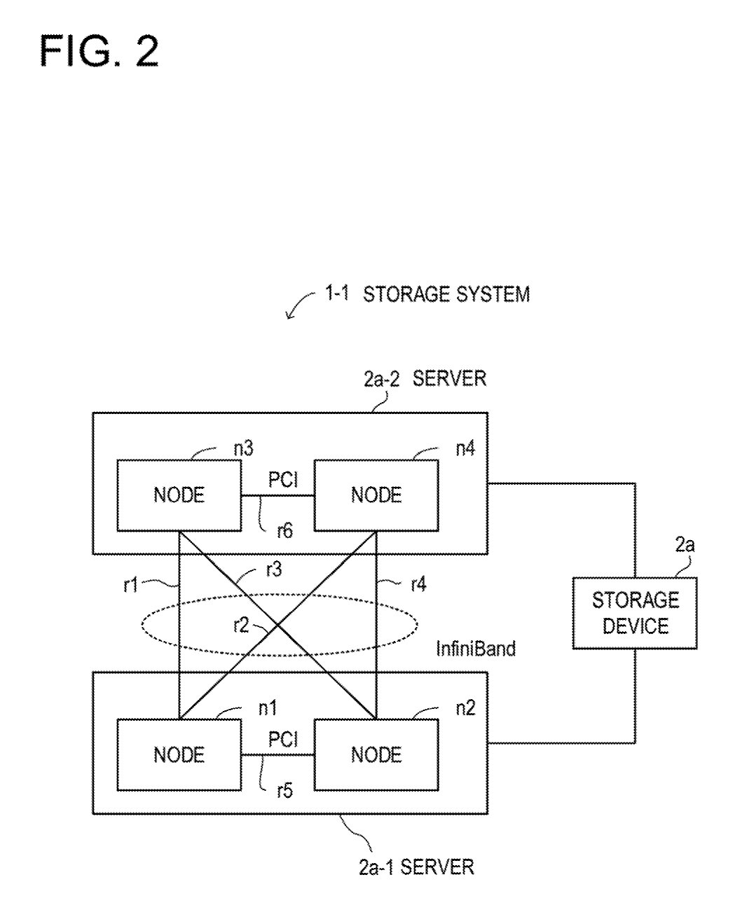

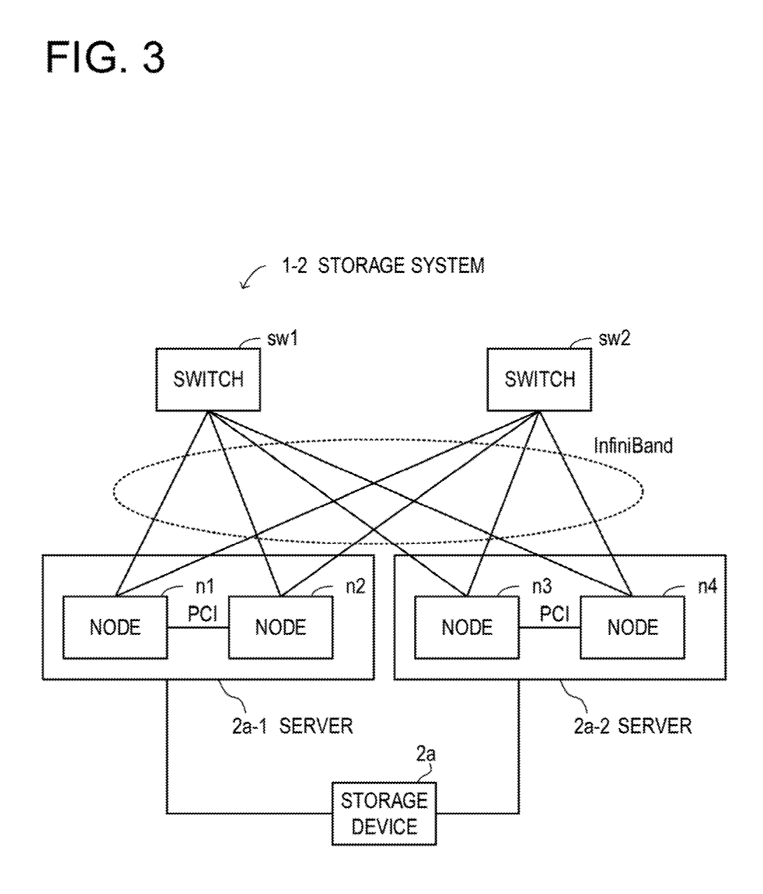

FIGS. 2 and 3 are diagrams illustrating an example of a configuration of a storage system. In FIG. 2, the storage system 1-1 includes a storage device 2a and servers 2a-1 and 2a-2. The server 2a-1 includes nodes n1 and n2, and the server 2a-2 includes nodes n3 and n4.

The node n1 is connected with the node n3 via the communication route r1 and connected with the node n4 via the communication route r2. In addition, a communication by the InfiniBand is performed between the nodes n1 and n3 and between the nodes n1 and n4.

Further, the node n2 is connected with the node n3 via the communication route r3 and connected with the node n4 via the communication route r4. In addition, the communication by the InfiniBand is performed between the nodes n2 and n3 and between the nodes n2 and n4.

Moreover, the node n1 is connected with the node n2 via the communication route r5, and a communication by the peripheral component interconnect (PCI) is performed between the nodes n1 and n2. Further, the node n3 is connected with the node n4 via the communication route r6, and the communication by the PCI is performed between the nodes n3 and n4.

In FIG. 3, the storage system 1-2 includes a storage device 2a, servers 2a-1 and 2a-2, and switches sw1 and sw2. Each of the nodes n1 to n4 is connected to scale-out switches sw1 and sw2, and the communication by the InfiniBand is performed between each node of the nodes n1 to n4 and the switches sw1 and sw2. Other basic components are the same as those in FIG. 2. Further, in FIGS. 2 and 3, the number of servers is two, but three or more servers may be system-designed by the scale-out. In addition, the number of nodes in one server may be three or more.

As described above, the communication by the PCI is performed between the nodes in the same server, and the communication by the InfiniBand is performed between the nodes passing through the server to enable a link operation of the node.

Further, as described above, in nodes n1 to n4, one port of the PCI and two ports of the InfiniBand are installed with respect to one node. Two ports of the InfiniBand are connected to an opposite node or a switch to attempt redundancy of the communication route of the InfiniBand.

Meanwhile, as the communication of the node, for example, a message communication of transmitting/receiving lightweight data and a direct memory access (DMA) transmission of transmitting data stored in a designated memory area are performed.

[Internal Configuration of Node]

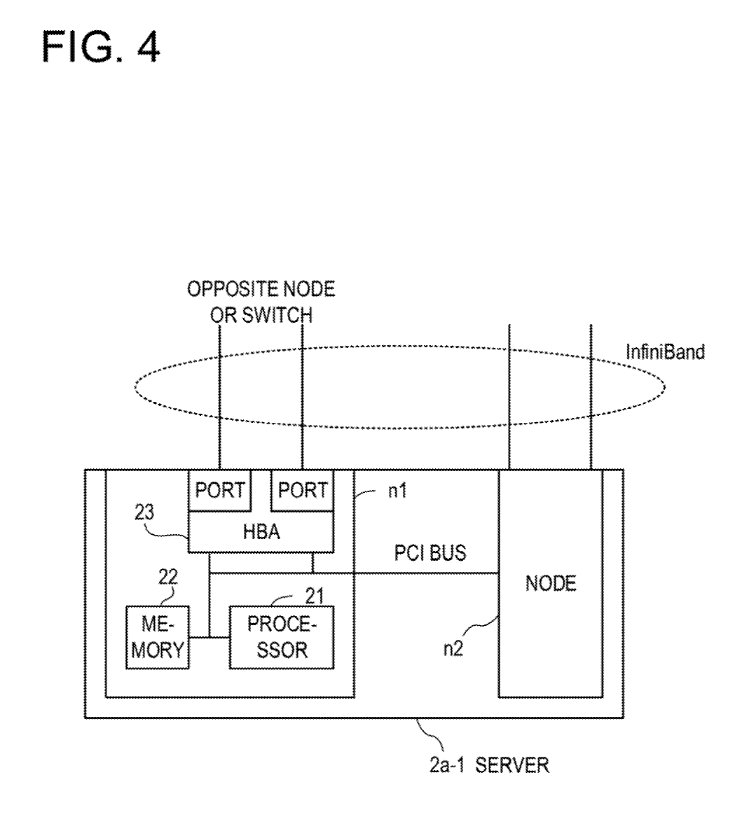

FIG. 4 is a diagram illustrating an example of an internal configuration of a node. The node n1 in the server 2a-1 includes a processor 21, a memory 22, and a host bus adapter (HBA) 23. The HBA 23 has two ports for the InfiniBand and is connected to the opposite node or switch. Further, the node n2, and the nodes n3 and n4 in the server 2a-2 have the same configuration.

[DMA Transmission]

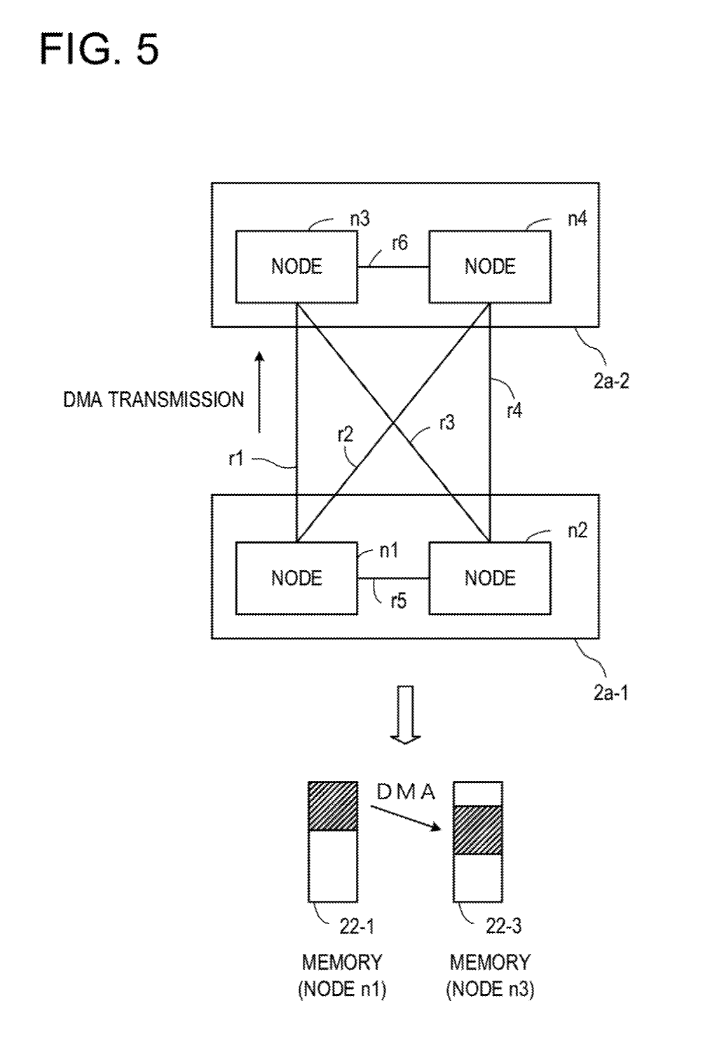

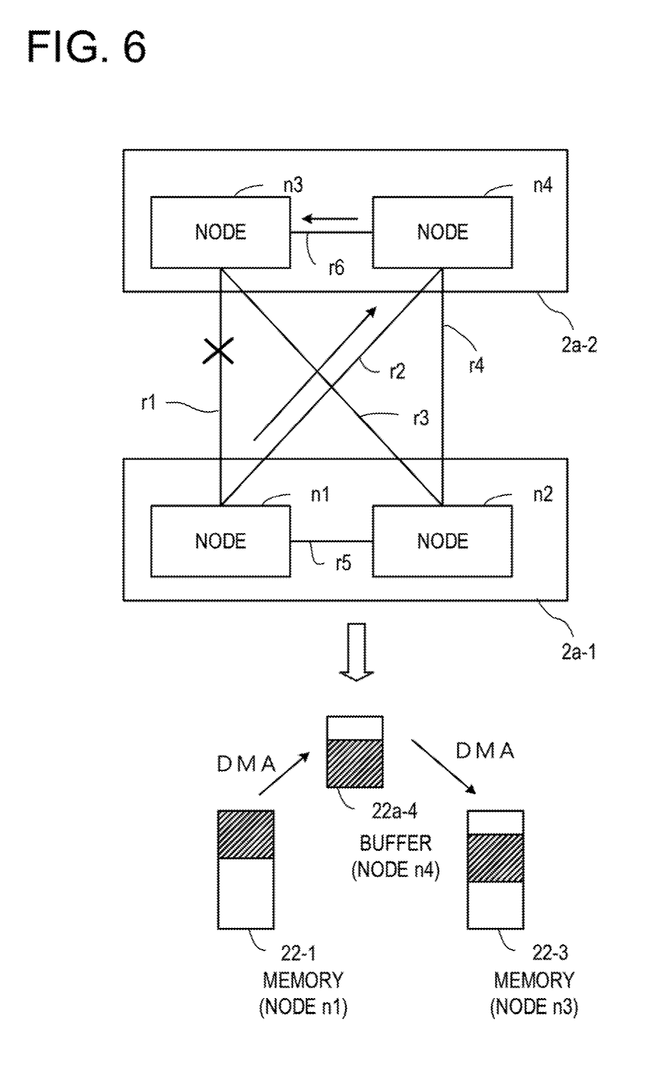

Next, the DMA transmission will be described with reference to FIGS. 5 and 6. FIG. 5 is a diagram illustrating an example of the DMA transmission. It is assumed that the node n1 performs the DMA transmission to the node n3 by the InfiniBand passing through the communication route r1. In this case, data stored in the memory 22-1 in the node n1 is transmitted to the memory 22-3 in the node n3.

FIG. 6 is a diagram illustrating an example of the DMA transmission 3o by the detour communication. It is assumed that the communication route r1 between the nodes n1 and n3 is blocked. When the communication route r1 is blocked, the node n1 may perform the DMA transmission to the node n4 by the detour communication through the communication route r2 of the InfiniBand at the other side.

In this case, the node n1 performs the DMA transmission to a buffer (e.g., a partial area in the memory of the node n4 is used as a buffer) reserved in the node n4 as a detour node in advance and then the node n4 performs DMA transmission to a desired node n3.

That is, the data stored in the memory 22-1 in the node n1 is transmitted to a buffer 22a-4 in the node n4, and the data buffered to the buffer 22a-4 is transmitted to the memory 22-3 in the node n4.

[Inexecutable State of Detour Communication]

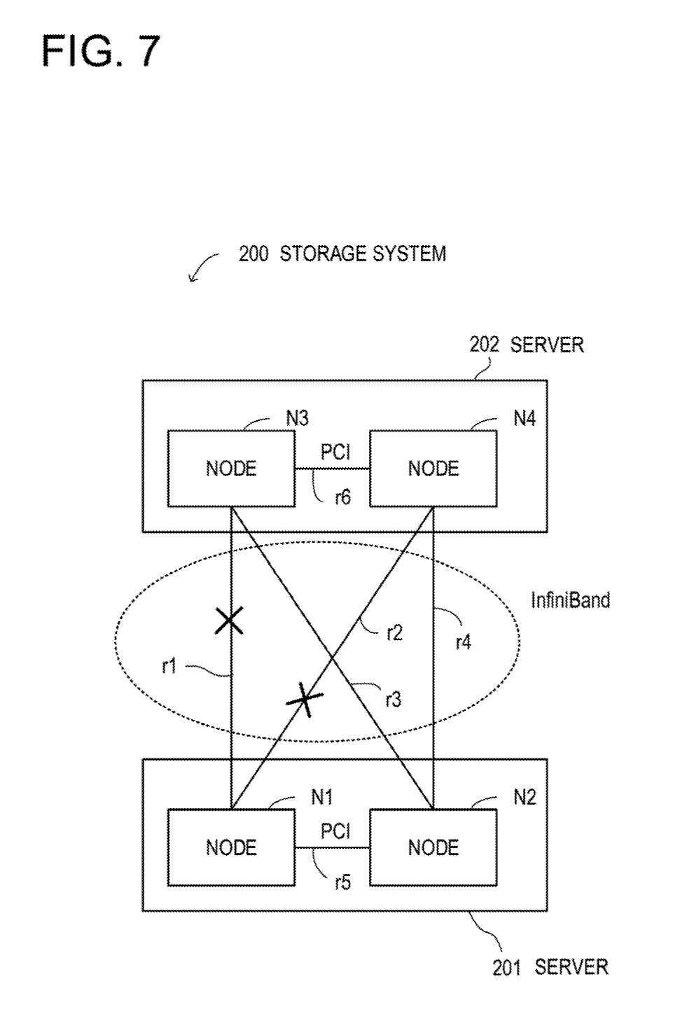

Here, a state in which the detour communication becomes inexecutable will be described with reference to FIG. 7. FIG. 7 is a diagram illustrating an example of a state in which the detour communication is inexecutable. The storage system 200 includes servers 201 and 202 (a storage device is not illustrated). The server 201 includes nodes N1 and N2, and the server 202 includes nodes N3 and N4. Further, a connection relationship is the same as that in FIG. 2.

The storage system 200 is configured in such a manner that the communication route of the InfiniBand at the other side is set as the detour route when the communication route at one side of the InfiniBand is blocked.

In the storage system 200, the redundancy of the detour route is only the InfiniBand, and the storage system 200 does not have a function of selecting a route that flows in the order of the nodes N1, N2, and N3 or a route that flows in the order of the nodes N1, N2, N4, and N3 as the detour route.

In such a configuration, when performing the DMA transmission from the node N1 to the node N3 by the InfiniBand communication via the communication route r1, as illustrated in FIG. 7, when a failure occurs in the communication routes r1 and r2, another detour route may not be selected, and as a result, the communication is discontinued.

As described above, when multiple failures occur in a communication route connected to one network interface unit (HBA) as illustrated in FIG. 7, the execution of the detour communication becomes impossible and inter-node communication may not be performed.

[Load Concentration State in Detour Communication]

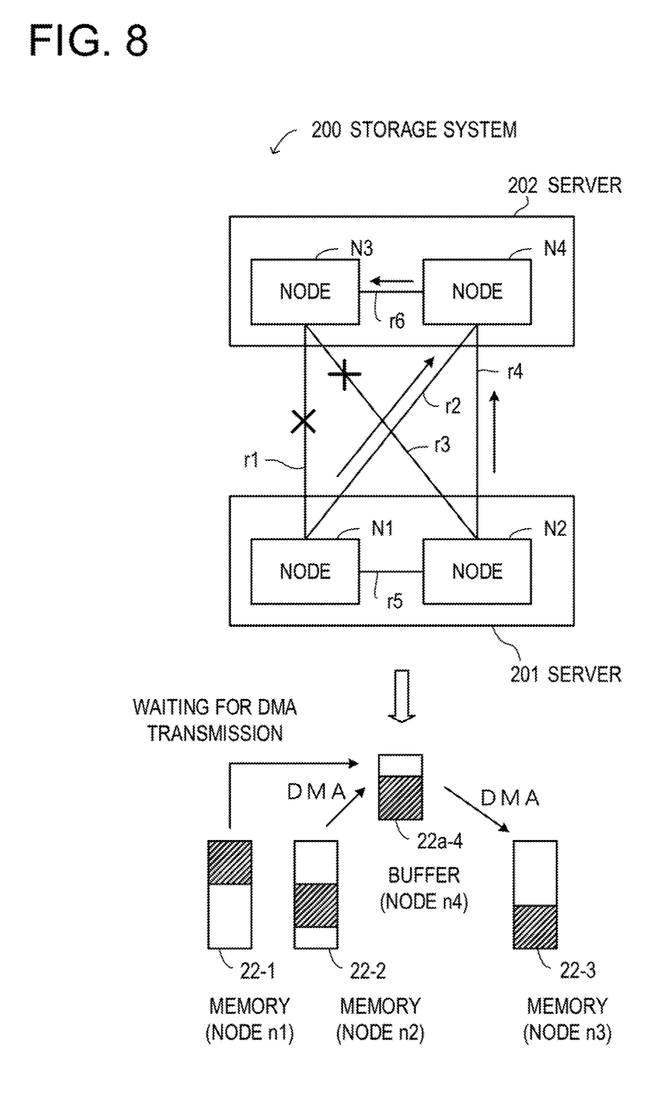

Next, a state in which the load concentrates on a specific node in the detour communication will be described with reference to FIG. 8. FIG. 8 is a diagram illustrating an example of a state in which a load concentrates on a specific node during the detour communication. In the storage system 200, when the node N1 performs the DMA transmission to the node N3, and the node N2 performs the DMA transmission to the node N3, the communication route r1 between the nodes N1 and N3 and the communication route r3 between the nodes N2 and N3 are blocked.

In this case, the node N1 performs the DMA transmission to the node N4 by the InfiniBand via the communication route r2. That is, the node N1 performs the DMA transmission to a buffer reserved in advance in the node N4 serving as the detour node, and then, the node N4 performs the DMA transmission to a desired node N3.

For example, the data stored in the memory 22-1 in the node N1 is transmitted to the buffer 22a-4 in the node N4, and the data buffered to the buffer 22a-4 is transmitted to the memory 22-3 in the node N3.

Meanwhile, the node N2 performs the DMA transmission to the node N4 by the InfiniBand via the communication route r4. In this case, the node N2 performs the DMA transmission to the buffer of the node N4 serving as the detour node, and thereafter, the node N4 performs the DMA transmission to the desired N3.

For example, the data stored in the memory 22-2 in the node N2 is transmitted to the buffer 22a-4 in the node N4, and the data buffered to the buffer 22a-4 is transmitted to the memory 22-3 in the node N3.

However, in the detour communication as described above, since the nodes N1 and N2 use the buffer 22a-4 of the node N4, a capacity shortage (exhaustion) of the buffer 22a-4 may occur, and when a capacity is insufficient, a DMA transmission waiting state may occur (in the example of FIG. 8, waiting for the DMA transmission occurs with respect to the node N1). As described above, when the detour communication is executed, there is a possibility that the load will concentrate on the node on the detour route.

The present disclosure has been made in view of the above points, and makes it possible to select a detour route even when a failure occurs in a plurality of communication routes, and, for example, shorten a set time of the detour route and reduce the processing load so as to improve the efficiency of the detour communication.

[Hardware Configuration]

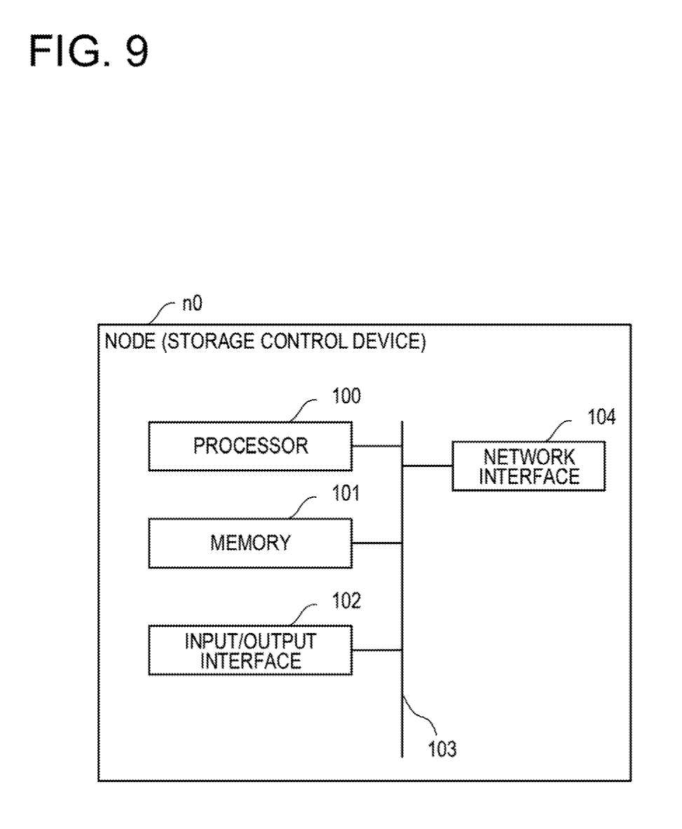

Next, a technology of a second embodiment will be described in detail. FIG. 9 is a diagram illustrating an example of a hardware configuration of a node. The nodes n1 to n4 (hereinafter, collectively referred to as a node n0) which are the storage control devices are totally controlled by a processor 100 (the processor 100 corresponds to the processor 21 of FIG. 4). That is, the processor 100 serves as a controller of the node n0.

The memory 101 and a plurality of peripheral devices are connected to the processor 100 via a bus 103 (the memory 101 corresponds to the memory 22 of FIG. 4). The processor 100 may be a multiprocessor. The processor 100 is, for example, a central processing unit (CPU), a micro processing unit (MPU), a digital signal processor (DSP), an application specific integrated circuit (ASIC), or a programmable logic device (PLD). Further, the processor 100 may be a combination of two or more elements among the CPU, the MPU, the DSP, the ASIC, and the PLD.

The memory 101 is used as a main memory device of the node n0. The memory 101 temporarily stores at least a part of a program of an operating system (OS) or an application program executed in the processor 100. Further, the memory 101 stores various data required for the processing by the processor 100.

In addition, the memory 101 is used even as a sub memory device of the node n0 and stores the program of the OS, the application program, and various messages. The memory 101 as a sub memory device may include a semiconductor memory device such as a flash memory or an SSD or a magnetic recording medium such as an HDD.

The peripheral device connected to the bus 103 includes an input/output interface 102 and a network interface 104. A monitor (e.g., a light emitting diode (LED) or a liquid crystal display (LCD)) which serves as a display device that displays a state of the node n0 according to a command from the processor 100 is connected to the input/output interface 102.

Further, the input/output interface 102 is capable of accessing an information input device such as a keyboard or a mouse and transmits a signal sent from the information input device to the processor 100.

The input/output interface 102 also serves as a communication interface for connecting the peripheral device. For example, the input/output interface 102 may connect an optical drive device that reads a message recorded on an optical disk using, for example, laser light. The optical disk is a portable recording medium on which the message is recorded so as to be readable by reflection of light. The optical disk includes a digital versatile disc (DVD), a DVD-random access memory (DVD-RAM), a compact disc read only memory (CD-ROM), and a CD-recordable (R)/rewritable (RW).

Further, the input/output interface 102 may connect a memory device and a memory reader/writer. The memory device is a recording medium having a communication function with the input/output interface 102. The memory reader/writer is a device that writes the message to a memory card or reads the message from the memory card. The memory card is a card type recording medium.

The network interface 104 implements an interface processing of a communication protocol of the HBA or the PCI. Further, the network interface 104 may have, for example, a function of a network interface card (NIC) or a wireless local area network (LAN) card. The signal or message received by the network interface 104 is output to the processor 100.

By the hardware configuration described above, a processing function of the node n0 may be implemented. For example, in the node n0, the processor 100 executes a predetermined program to perform the control of the present disclosure.

The node n0 implements the processing function of the present disclosure by executing, for example, a program recorded in a computer readable recording medium. The program that describes processing contents executed by the node n0 may be recorded in various recording media.

For example, the program that is executed by the node n0 may be stored in the sub memory device. The processor 100 loads at least a part of the program in the sub memory device into the main memory device and executes the program. Further, the program may be recorded in the portable recording medium such as the optical disk, the memory device, or the memory card. The program stored in the portable recording medium may be executed after being installed in the sub memory device, for example, under the control of the processor 100. Further, the processor 100 may read and execute the program directly from the portable recording medium.

[Functional Block]

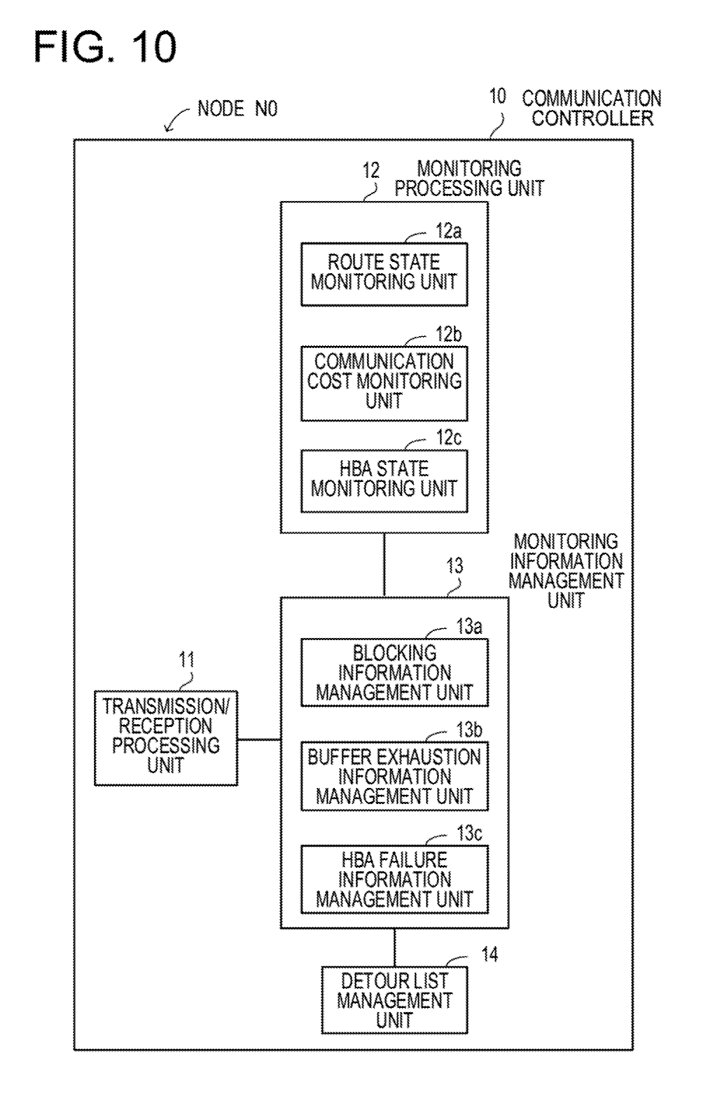

FIG. 10 is a diagram illustrating an example of a functional block of the node. The node n0 includes a communication controller 10, and the communication controller 10 includes a transmission/reception processing unit 11, a monitoring processing unit 12, a monitoring information management unit 13, and a detour list management unit 14.

In order to share information with another node, the transmission/reception processing unit 11 transmits predetermined information to another node and receives the predetermined information from another node. The monitoring processing unit 12 includes a route state monitoring unit 12a, a communication cost monitoring unit 12b, and an HBA state monitoring unit 12c. The route state monitoring unit 12a monitors blocking and opening of the communication route.

The communication cost monitoring unit 12b monitors at least one of, for example, a exhaustion state of a memory capacity of the node and a processor processing load state (communication load state) as communication cost (corresponding to a communication restriction). Further, in the following description, it will be mainly described that a storage state (e.g., whether the memory capacity is exhausted) of the buffer of the node is monitored. The HBA state monitoring unit 12c monitors the failure and recovery of the HBA.

The monitoring information management unit 13 includes a blocking information management unit 13a, a buffer exhaustion information management unit 13b, and an HBA failure information management unit 13c. The monitoring information management unit 13 holds the monitoring information monitored by the monitoring processing unit 12 of its own node, holds the monitoring information transmitted from another node, and updates the monitoring information according to a change of the monitoring information.

The blocking information management unit 13a stores and manages the communication route in the blocked state. The buffer exhaustion information management unit 13b stores and manages a node that exhausts the buffer. The HBA failure information management unit 13c stores and manages which HBA in the node is faulty.

Further, the monitoring information stored and managed by the monitoring information management unit 13 is transmitted to another node by the transmission/reception processing unit 11. In addition, the monitoring information transmitted from another node is received by the transmission/reception processing unit 11, and the monitoring information management unit 13 updates the monitoring information based on the received monitoring information. The processing is performed, and as a result, latest monitoring information is shared by all nodes.

The detour list management unit 14 refers to the monitoring information managed by the monitoring information management unit 13 at regular intervals or each time the monitoring information is updated, and updates the detour route when a currently stored detour route is changed according to the change of the monitoring information.

Further, a list of detour routes (detour list) managed by the detour list management unit 14 is transmitted to another node by the transmission/reception processing unit 11. In addition, the detour list information transmitted from another node is received by the transmission/reception processing unit 11, and the detour list is updated based on the received detour list information. The processing is performed, and as a result, the latest detour list is shared by all nodes.

Further, the transmission/reception processing unit 11 is implemented by the network interface 104 illustrated in FIG. 9. The monitoring processing unit 12 is implemented by the processor 100 illustrated in FIG. 9. The storing functions of the monitoring information management unit 13 and the detour list management unit 14 are implemented by the memory 101 illustrated in FIG. 9.

[Flow from Generation of Block Route to Detour Communication]

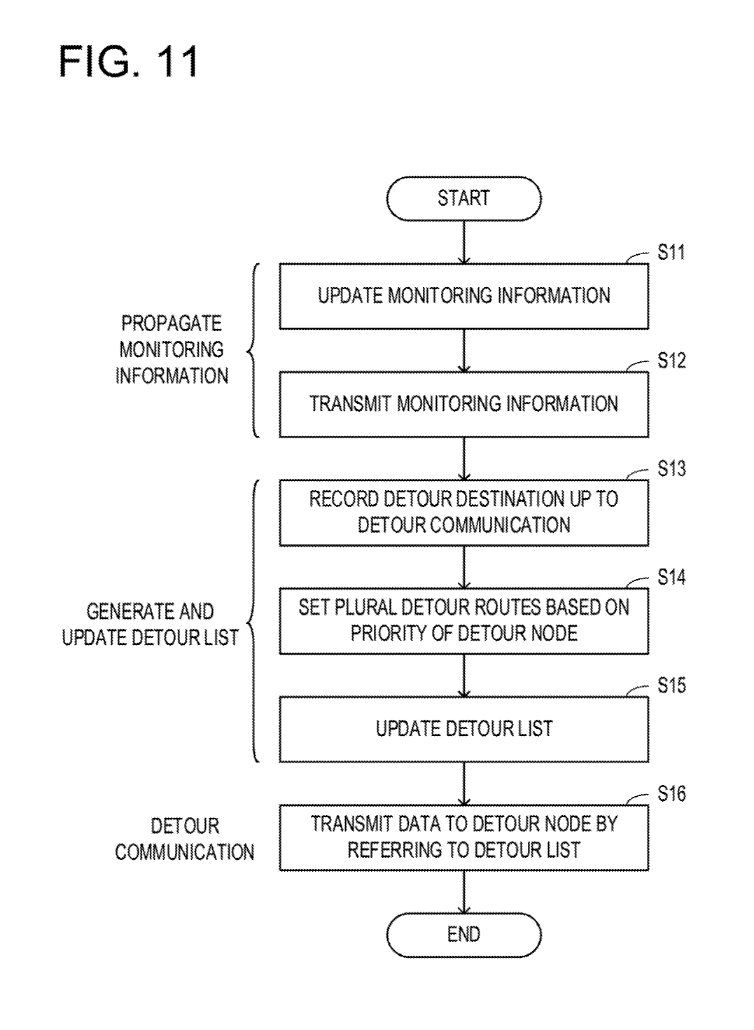

FIG. 11 is a flowchart illustrating an operation from the generation of a blocked path until the execution of the detour communication.

(Operation S11) The communication controller 10 updates the monitoring information (blocking information, buffer exhaustion information, and HBA failure information).

(Operation S12) The communication controller 10 transmits the updated monitoring information to another node. In this case, the updated monitoring information is transmitted so that a transmission destination node does not overlap. The monitoring information is propagated to all nodes by operations of operations S11 and S12.

(Operation S13) The communication controller 10 records information, in the detour list, to which adjacent node (detour destination) data is to be transmitted from its own node, with respect to a reception destination node that needs to detour.

(Operation S14) The communication controller 10 sets the detour route based on the detour list. Further, the communication controller 10 may predict, for example, buffer exhaustion and set, for example, two detour routes (priority detour route and preliminary detour route).

(Operation S15) The communication controller 10 updates the detour list every time the monitoring information is updated. The detour list is generated and updated by the operations of operations S13, S14, and S15.

(Operation S16) When performing the detour communication, the communication controller 10 refers to the detour list and transmits the data to the detour node recorded in the operation S14. By the operation of operation S16, the detour communication is performed.

[Table Configuration of Monitoring Information]

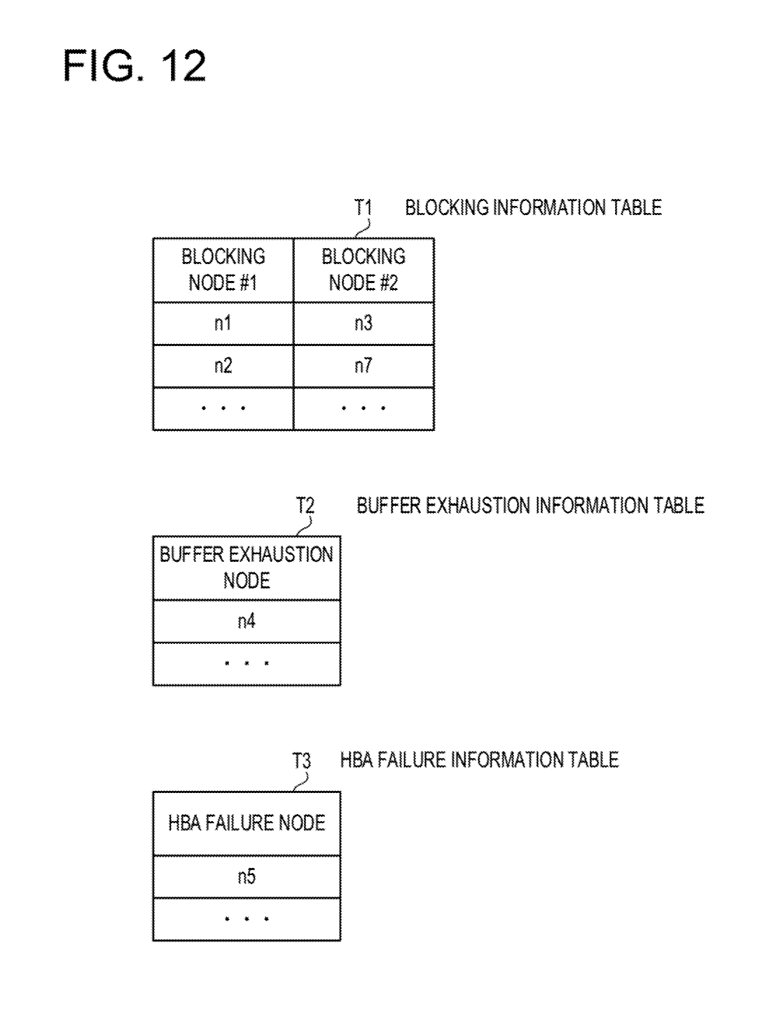

FIG. 12 is a diagram illustrating an example of a table configuration of monitoring information. A blocking information table T1 is generated by the blockage information management unit 13a and has blocking nodes #1 and #2 as items.

In the example of FIG. 12, blocking node #1=n1 and blocking node #2=n3, which indicates that the communication route between the nodes n1 and n3 is in the blocked state. Similarly, blocking node #1=n2 and blocking node #2=n7, which indicates that the communication route between the nodes n2 and n7 is in the blocked state.

The buffer exhaustion information table T2 is generated by the buffer exhaustion information management unit 13b and has a buffer exhaustion node as the item. In the example of FIG. 12, the buffer exhaustion node=n4, which indicates that the capacity of the buffer (the buffer when used in the DMA transmission) of the node n4 is exhausted.

The HBA failure information table T3 is generated by the HBA failure information management unit 13c and has an HBA failure node as the item. In the example of FIG. 12, the HBA failure node=n5, which indicates that the HBA of the node n5 is faulty.

Further, a state in which the processing load of the processor of the node is high may be detected as the monitoring information, and the detected processor processing load may be table-managed.

[Management of Blocking Information in Each Node]

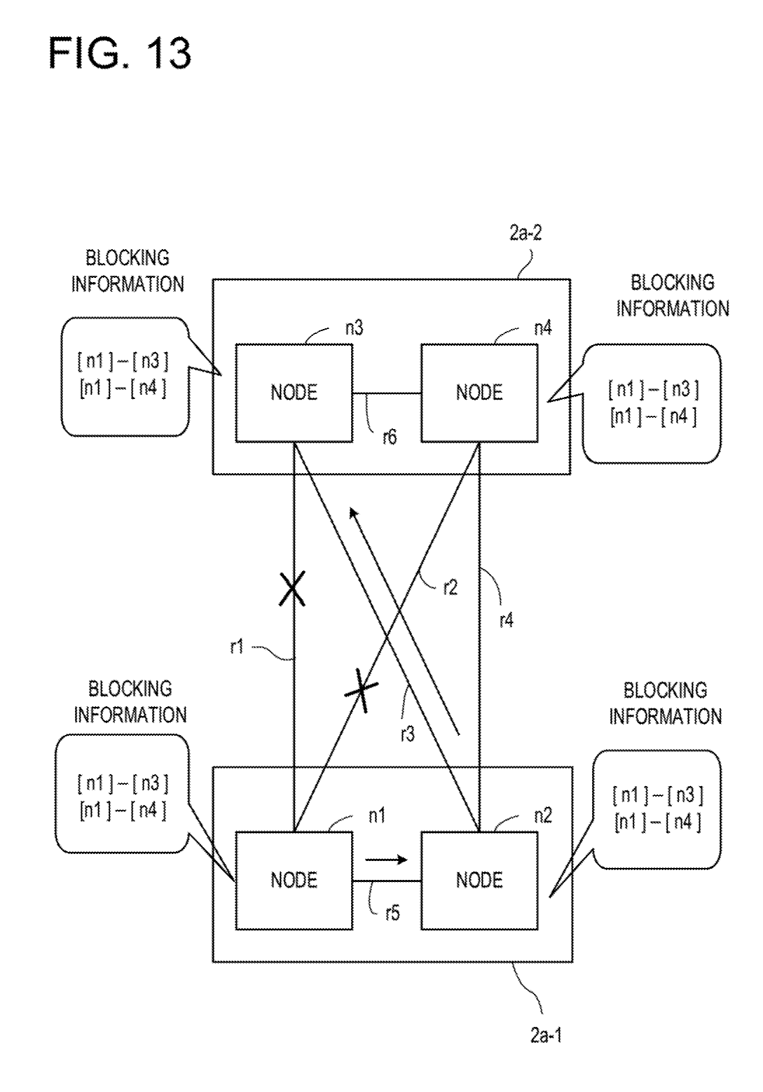

FIG. 13 is a diagram illustrating an example of the management of the blocked route in each node. Each of the nodes n1 to n4 stores and manages the blocking information. Further, [n1]-[n3] in FIG. 13 indicates that the communication route between the nodes n1 and n3 is blocked, and [n1]-[n4] indicates that the communication route between the nodes n1 and n4 is blocked.

It is assumed that the communication routes r1 and r2 are blocked. In this case, each of the nodes n1 to n4 stores and manages [n1]-[n3] and [n1]-[n4] as the blocking information.

As described above, since each node shares and manages the same blocked route, it becomes unnecessary to refer to the routing information to another node every time the communication is performed. Further, since only information of the blocked route is held, it becomes unnecessary to store all routing tables and the memory capacity may be reduced and table search cost is also reduced.

[Management of HBA Failure Information in Each Node]

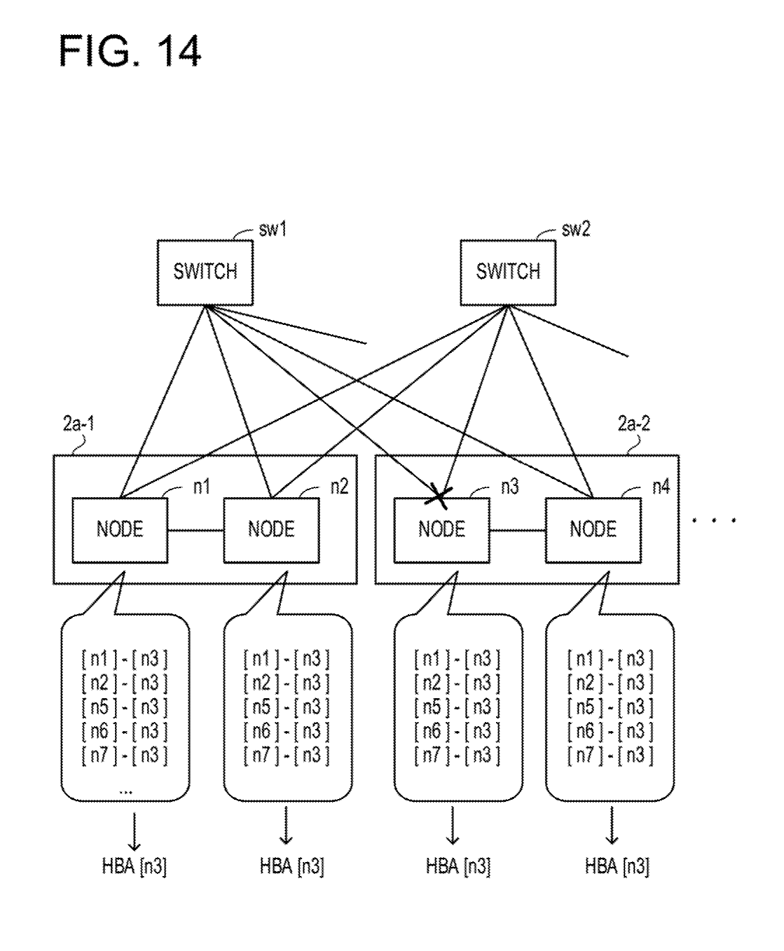

FIG. 14 is a diagram illustrating an example of the management of the HBA failure information in each node. In the system configuration illustrated in FIG. 14, it is assumed that the HBA in the node n3 is faulty. Further, HBA[n3] in FIG. 14 indicates that the HBA of the node n3 is faulty.

In this case, the management method of the blocking information as described above in FIG. 13, for example, the node n1 stores information such as [n1]-[n3], [n2]-[n3], [n5]-[n3], [n6]-[n3], [n7]-[n3], . . . (the same applies to, for example, the nodes n2, n3, and n4).

However, as actually illustrated in FIG. 12, each node has the HBA failure information table T3 and manages HBA failure information separately from the blocking information. Thus, each node stores and manages HBA failure information of HBA[n3], and as a result, information of the blocked route which is not connected with the node n3 may be integrated, stored, and managed, and the memory capacity may be reduced.

[Detour List]

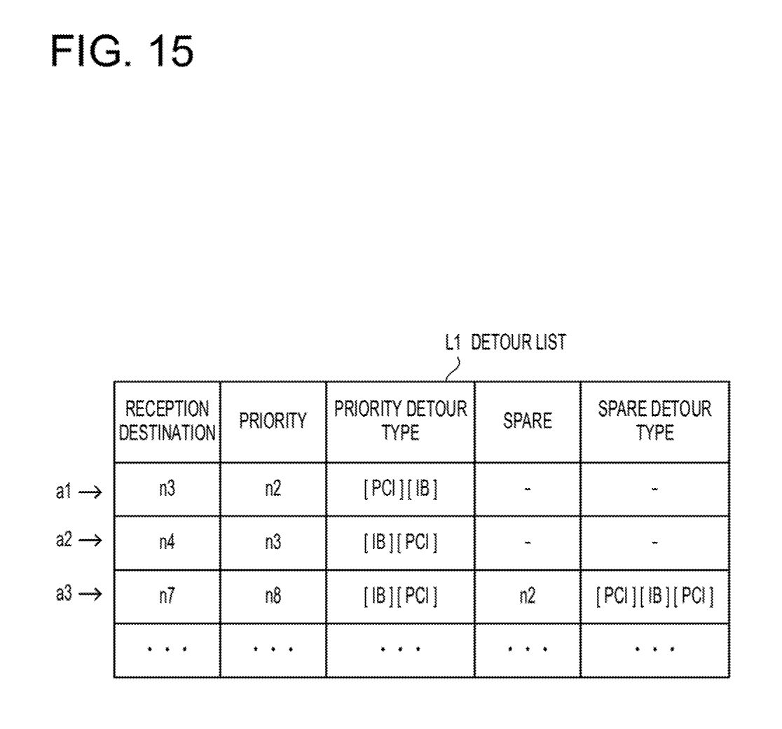

FIG. 15 is a diagram illustrating an example of a detour list. The detour list L1 is generated by the detour list management unit 14 and has a reception destination, a priority, a priority detour type, a spare, and a spare detour type as the items.

For example, in column a1, (reception destination, priority, priority detour type, spare, spare detour type)=(n3, n2, [PCI] [IB], -, -). This indicates that a desired transmission destination node is the node n3, and the priority detour destination node adjacent to its own node is the node n2. In addition, it is indicated that data transfer processing is performed in the order of PCI and InfiniBand (IB) in the detour communication from the own node to the node n3 via the node n2.

In the column a2, (reception destination, priority, priority detour type, spare, spare detour type)=(n4, n3, [IB][PCI], -, -). This indicates that the desired transmission destination node is the node n4, and the priority detour destination node adjacent to the own node is the node n3. In addition, it is indicated that data transfer processing is performed in the order of InfiniBand and PCI in the detour communication from the own node to the node n4 via the node n3.

In the column a3, (reception destination, priority, priority detour type, spare, spare detour type)=(n7, n8, [IB][PCI], n2, [PCI][IB][PCI]). This indicates that the desired transmission destination node is the node n7 and the priority detour destination node adjacent to its own node is the node n8. It is indicated that when the priority detour destination node is the node n8, the data transfer processing is performed in the order of InfiniBand and PCI in the detour communication from the own node to the node n7 via the node n8.

Further, in the column a3, it is indicated that the spare detour destination node adjacent to the own node is the node n2. Further, it is indicated that when the spare detour destination node is the node n2, the data transfer processing is performed in the order of PCI, InfiniBand, and PCI in the detour communication from the own node to the node n7 via the node n2.

Here, in a data transmission between different communication protocols, the data transfer processing is performed on software. When the data transfer processing is performed, a data transfer time or communication cost increases accordingly.

Therefore, in the case of performing the detour communication, the priority is set so as to preferentially select a route with a smaller number of data transfer processes. Therefore, as described in the column a3, the detour destination (node n8) with a small number of data transfer processes of the communication protocol is set to have a higher priority than the detour destination (node n2). Further, in addition to the number of data transfer processes, the priority of the detour destination with small communication cost may be set high.

[Detection of Monitoring Information and Transmission of Monitoring Information to Another Node]

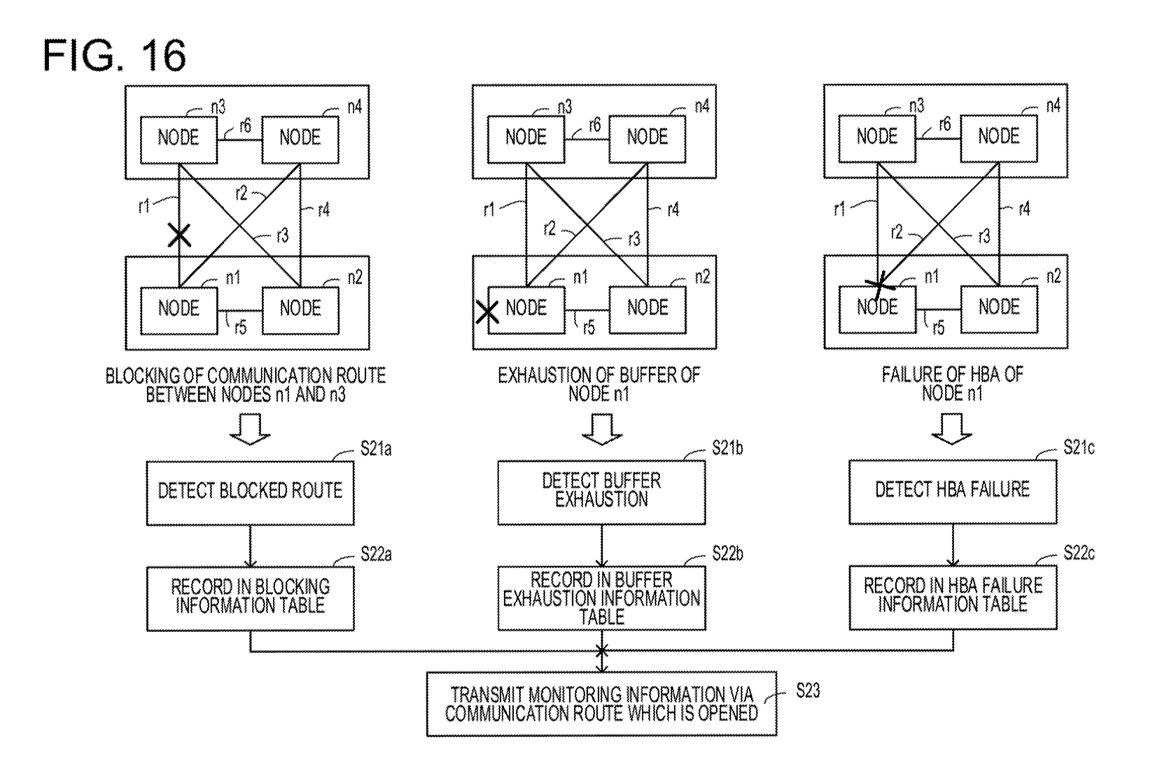

FIG. 16 is a diagram for describing an example of detection of the monitoring information and transmission of the monitoring information to another node. Further, it is assumed that the communication route between the nodes n1 and n3 is blocked as the blocking of the communication route. In addition, it is assumed that the buffer of the node n1 is exhausted as the buffer exhaustion. Moreover, it is assumed that the HBA of the node n1 is faulty as the HBA failure.

(Operation S21a) The communication controller 10 of the node n1 detects the blocking of the communication route r1 between the nodes n1 and n3.

(Operation S22a) The communication controller 10 of the node n1 records (blocking nodes #1, #2)=(n1, n3) in the blocking information table T1 as the detected blocking information.

(Operation S21b) The communication controller 10 of the node n1 detects capacity exhaustion of the buffer in the node n1.

(Operation S22b) The communication controller 10 of the node n1 records the node n1 in the buffer exhaustion information table T2.

(Operation S21c) The communication controller 10 of the node n1 detects the failure of the HBA of the node n1.

(Operation S22c) The communication controller 10 of the node n1 records the node n1 in the HBA failure information table T3.

(Operation S23) The communication controller 10 of the node n1 notifies each monitoring information recorded in the blocking information table T1, the buffer exhaustion information table T2, and the HBA failure information table T3 via a communication route of which opening is completed. Further, the node that has received each piece of monitoring information transmits and propagates the received monitoring information to another node via the communication route of which opening is completed.

In the propagation of the blocking information (corresponding to the route blocking information), the communication controller 10 of the node n1 transmits the blocking information [(blocking nodes #1, #2)=(n1, n3)] to the node n2 in the same server via the communication route r5.

Further, the communication controller 10 of the node n3 transmits the blocking information [(blocking nodes #1, #2)=(n1, n3)] to the node n4 in the same server via the communication route r6.

In the propagation of the buffer exhaustion information (corresponding to the communication cost information), the communication controller 10 of the node n1 transmits buffer exhaustion information [n1] to the node n3 in the opposite server via the communication route r1 and transmits the buffer exhaustion information [n1] to the node n2 in the same server via the communication route r5.

The communication controller 10 of the node n3 transmits the received buffer exhaustion information [n1] to the node n4 in the same server via the communication route r6.

In the propagation of the HBA failure information (corresponding to the route blocking information), the communication controller 10 of the node n1 transmits the HBA failure information [n1] to the node n2 in the same server via the communication route r5. The communication controller 10 of the node n2 transmits the received HBA failure information [n1] to the node n3 in the opposite server via the communication route r3.

The communication controller 10 of the node n3 transmits the received HBA failure information [n1] to the node n4 in the same server via the communication route r6.

Further, when recovering the communication route, when resolving a buffer exhaustion state, and when spreading the HBA failure, information to be deleted in the table is propagated in the same flow as described above and predetermined information is deleted from the table.

Here, when a route blocking detection node that detects the blocked route, the buffer exhaustion, or the HBA failure transmits the monitoring information, target node selection logic is, for example, as follows.

(1) The route blocking detection node transmits the monitoring information to a node connected thereto in the same server (via PCI). Further, in a case where the communication route via the InfiniBand is completely blocked, a flag indicating the case is transmitted while being granted monitoring information to be transmitted and transmitted. As a result, since the node that has received the corresponding flag stops search processing of the opposite node for relaying and transmitting the monitoring information, the node may reduce the processing load.

(2) The route blocking detection node transmits the monitoring information to a node located in a direction with a smaller number of transmission target nodes, with its own node ID as a boundary. For example, when all nodes are eight nodes of the nodes n1 to n8 and the corresponding node is the node n5, the monitoring information is transmitted to any one of the nodes n6, n7, and n8 with a small number of transmission target nodes with the node n5 as the boundary.

Transmission of duplicate monitoring information to the same node may be suppressed by transmitting the monitoring information to another node by the logic described above.

[Reception Processing of Monitoring Information]

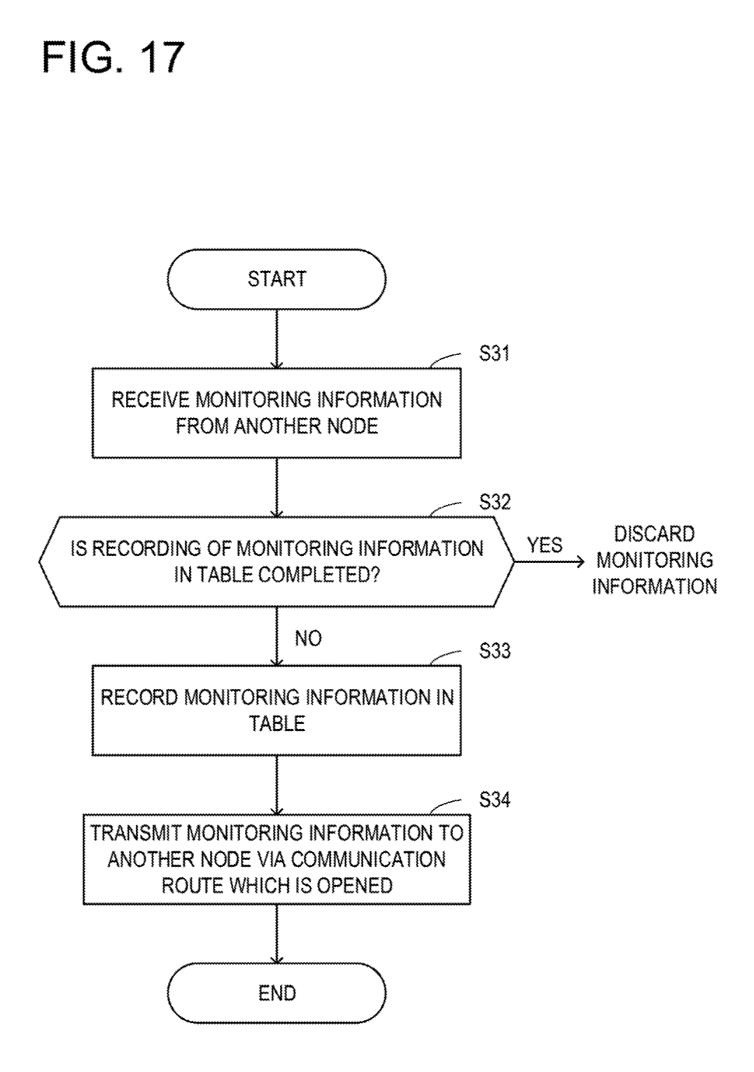

FIG. 17 is a flowchart illustrating an operation of a receiving process of the monitoring information.

(Operation S31) The communication controller 10 receives the monitoring information transmitted from another node.

(Operation S32) The communication controller 10 determines whether recording the received monitoring information in the table is completed. When it is determined that recording the received monitoring information in the table is completed, the information is discarded, and otherwise, the processing proceeds to operation S33.

(Operation S33) The communication controller 10 records the received monitoring information in the table (e.g., records the received monitoring information in the blocking information table T1 when the received monitoring information indicates the blocked route).

(Operation S34) Each monitoring information recorded in the blocking information table T1, the buffer exhaustion information table T2, and the HBA failure information table T3 is notified and propagated via the communication route of which opening is completed.

Here, for example, as the target node selection logic when the node receiving the notified monitoring information transmits and propagates the corresponding monitoring information to another node, for example, the monitoring information received via the InfiniBand is transmitted to the adjacent node in the same server. Further, the transmission of the monitoring information received to another node via the PCI stops (however, when the route for the InfiniBand of the adjacent node is entirely blocked, the monitoring information is transmitted as the same selection logic as the route blocking detection node).

[Updating Process of Detour List]

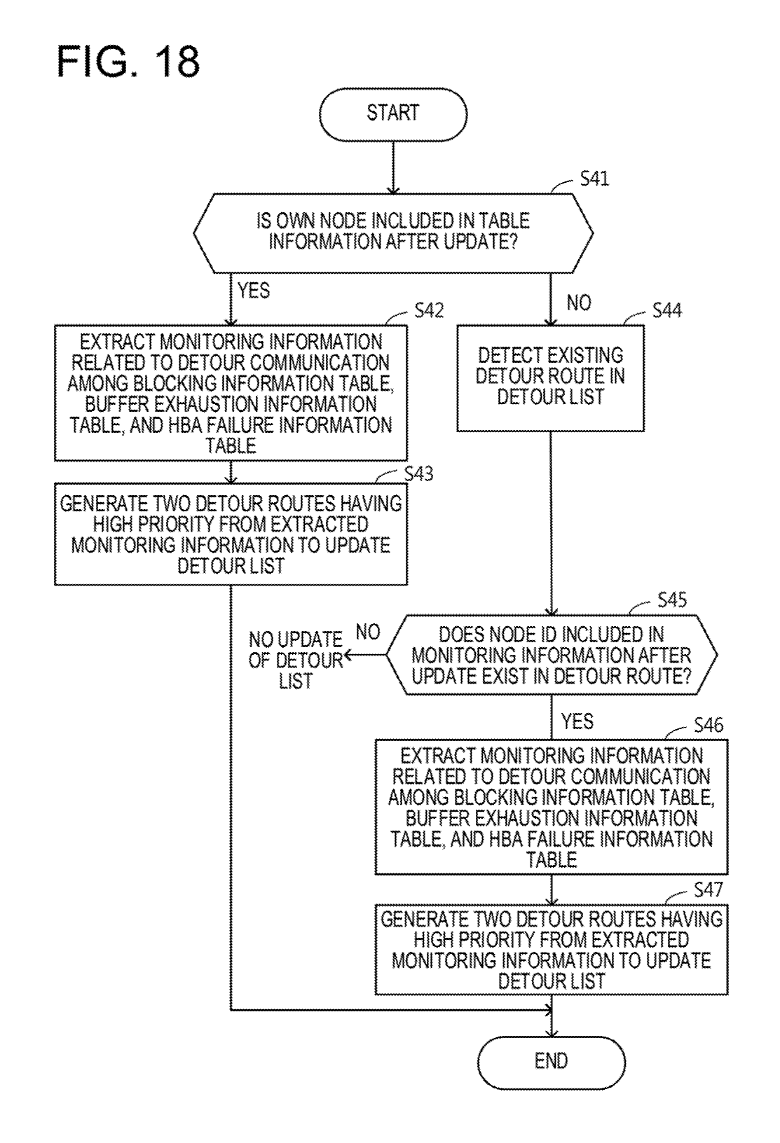

FIG. 18 is a flowchart illustrating an operation of an updating process of the detour list.

(Operation S41) The communication controller 10 determines whether its own node is included in the updated table information (the information of each table illustrated in FIG. 12). When it is determined that the own node is included, the process proceeds to operation S42, and when it is determined that the own node is not included, the process proceeds to operation S44.

(Operation S42) The communication controller 10 extracts monitoring information related with the detour communication in the blocking information table T1, the buffer exhaustion information table T2, and the HBA failure information table T3.

(Operation S43) The communication controller 10 generates two detour routes with a high priority from the extracted monitoring information to update registration contents of the detour list L1.

(Operation S44) The communication controller 10 detects the existing detour route from the detour list L1.

(Operation S45) The communication controller 10 determines whether a node ID included in the updated monitoring information is included in the detected detour route.

That is, the communication controller 10 determines whether a node connected to a newly generated blocked route, a node in which the buffer is exhausted, or a node where the HBA is faulty is included among the nodes constructing the existing detour route based on the node ID.

When the node ID is included in the existing detour route, the process proceeds to operation S46. When the node ID is not included in the existing detour route, since the existing detour route is not affected, the detour list L1 is not updated.

(Operation S46) The communication controller 10 extracts the monitoring information related with the detour communication in the blocking information table T1, the buffer exhaustion information table T2, and the HBA failure information table T3.

(Operation S47) The communication controller 10 generates two detour routes with the high priority from the extracted monitoring information to update the registration contents of the detour list L1.

Further, as the setting of the priority, for example, in order of the high priority, [IB][PCI]>[PCI][IB]>[IB][PCI][via buffer exhaustion node]>[PCI][IB][via the buffer exhausted node]>[PCI][IB][PCI]>(completely blocked).

[Detour Communication Processing]

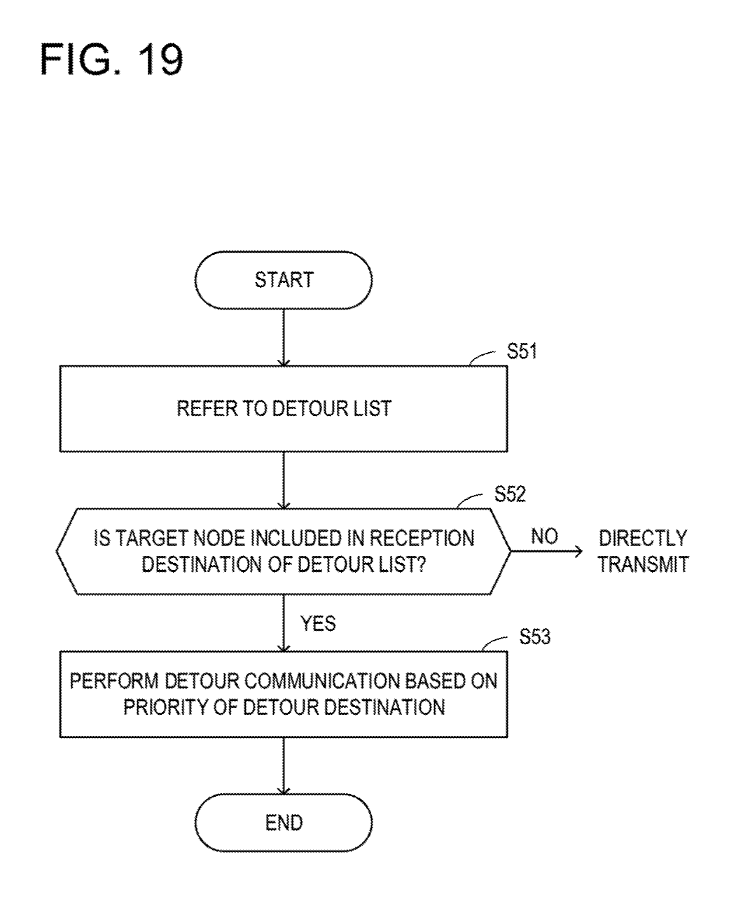

FIG. 19 is a flowchart illustrating an operation of a detour communication process.

(Operation S51) When the message or data is transmitted to a target node, the communication controller 10 refers to the detour list L1.

(Operation S52) The communication controller 10 determines whether the target node is included in the “reception destination” in the detour list L1. When it is determined that the target node is included in the “reception destination,” the process proceeds to operation S53, and when it is determined that the target node is not included in the “reception destination,” the message or data is directly transmitted to the target node.

(Operation S53) The communication controller 10 detour-communicates the message or data to the node described in “priority” in the detour list L1. For example, in FIG. 15, when the target node is the node n7, the detour communication is performed to the node n8 based on the detour list L1.

Further, in the detour list L1, when it is determined that the target node is included in the “reception destination,” and there are two candidates “priority” and “spare,” in principle, the detour communication to the node described in “priority” Is performed, but a determination may be made by considering the communication cost (e.g., the buffer exhaustion state and the processor processing load) to perform the detour communication to the node described in “spare.”

For example, in the detour list L1 of FIG. 15, in a case where the target node is the node n7, the “priority” of the detour list L1 is described as the node n8, so that in principle the detour communication to the node n8 is performed.

However, for example, in a case where the buffer of the node n8 is exhausted, or a case where the processor processing load of the node n8 is high, the node n2 described in the spare of the detour list L is selected and the detour communication may be performed for the node n2.

[Operation Example of Detour Communication]

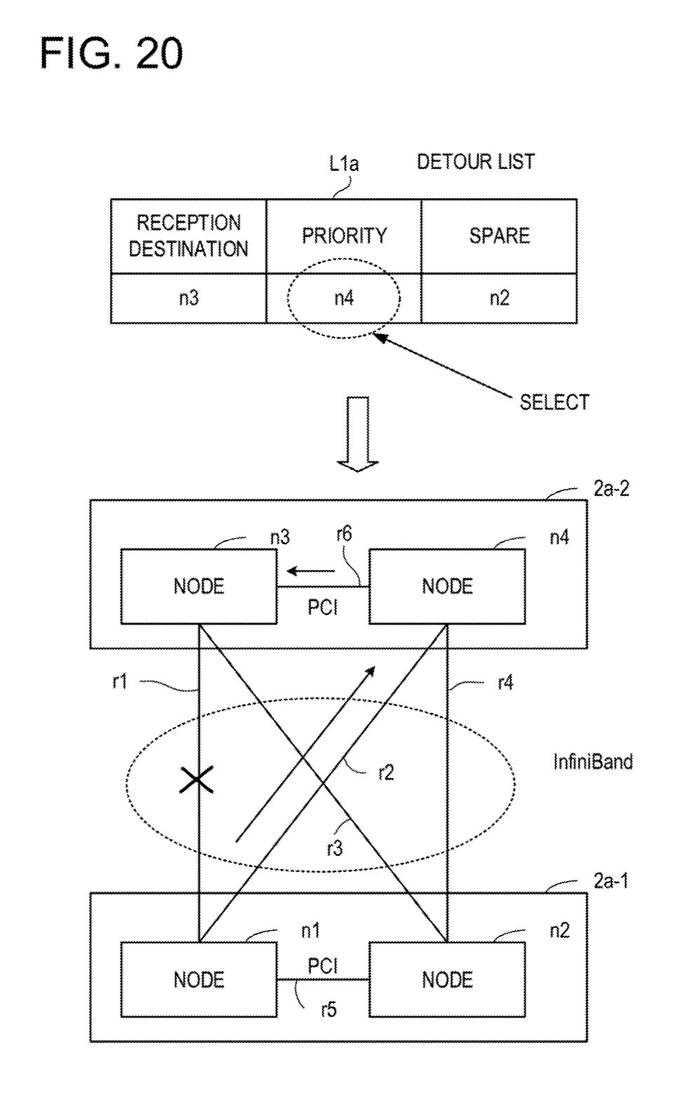

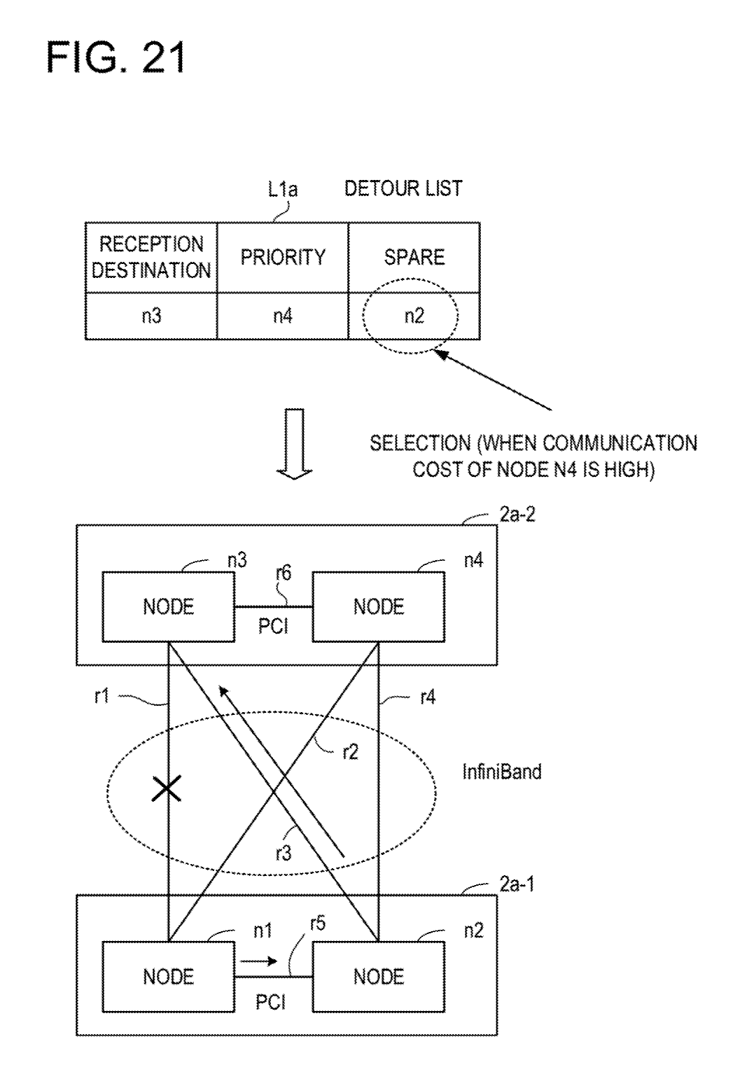

Next, an operation example of the detour communication will also be described with reference to FIGS. 20 and 21. FIGS. 20 and 21 are diagrams for describing an example of the operation of the detour communication. In FIG. 20, it is assumed that when the data is transmitted from the node n1 to the node n3, the blocking occurs in the communication route r1. The communication controller 10 in the node n1 generates and manages a detour list L1a.

The detour list L1a has the reception destination, the priority, and the spare as the items (the priority detour type and the spare detour type are omitted). In the detour list L1a, (reception destination, priority, spare)=(n3, n4, n2) is set.

In the case of the detour communication from the node n1 to the node n3, the order of data transfer is [IB][PCI] when passing through the node n4 and the order of data transfer is [PCI][IB] when passing through the node n2.

As described above with reference to FIG. 18, the priority level is [IB][PCI]>[PCI][IB]. That is, the detour destination (node n4) that makes the data transfer process unnecessary to the node n1 has a higher priority than the detour destination (node n2) that is required for the data transfer process. Therefore, in the detour list L1a, the priority of the node n4 is set higher than that of the node n2. Therefore, the detour communication is performed in order of the node n1, the node n4, and the node n3.

In FIG. 21, it is assumed that the communication cost of the node n3 is higher than the communication cost of the node n2. For example, it is assumed that the buffer of the node n3 is in an exhausted stated or the processor processing load of the node n3 exceeds a threshold value.

In such a case, the communication controller 10 of the node n1 selects the spare node n2 set in the detour list L1a as the detour destination. Therefore, the detour communication is performed in order of the nodes n1, n2, and n3.

As described above, according to the present disclosure, it is possible to readily search for another detour route at the time of multiple failures of the communication route, and improve the reliability of the inter-node communication. Further, in a situation where the buffer used at the time of the DMA transmission tends to be exhausted, another detour route may be selected and passed so that a load distribution may be efficiently performed. Furthermore, it is also possible to implement the detour to a node that places importance on the processor processing performance.

The processing functions of the storage system and the node (storage control device) of the present disclosure described above may be implemented by a computer. In this case, a program describing the processing contents of the functions that the storage system and the node need to have is provided. By executing the program by the computer, the processing function is implemented on the computer.

The program that describes the processing contents may be recorded in a computer-readable recording medium. The computer-readable recording medium includes, for example, a magnetic memory device, an optical disk, and a semiconductor memory. The magnetic memory device includes, for example, a hard disk device (HDD), a flexible disk (FD), and a magnetic tape. The optical disk includes, for example, a CD-ROM/RW.

When distributing a program, for example, a portable recording medium such as CD-ROM in which the program is recorded may be sold. Further, the program may be stored in a memory device of a server computer and transferred from the server computer to another computer via a network.

The computer that executes the program stores the program recorded in, for example, a portable recording medium or the program transferred from the server computer, in the memory device thereof. In addition, the computer reads the program from the memory device thereof and executes the processing according to the program. Further, the computer may read the program directly from the portable recording medium and execute the processing according to the program.

In addition, each time the program is transferred from a server computer connected via the network, the computer may sequentially execute the processing according to the received program. Further, at least a part of the above processing functions may be implemented by electronic circuits such as a DSP (Digital Signal Processing), an ASIC (Application Specific Integrated Circuit), and a PLD (Programmable Logic Device).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage system comprising:
a storage device; and
a plurality of storage control devices configured to couple to each other through a plurality of communication routes, a first storage control device of the plurality of storage control devices configured to include:
a memory; and
a processor coupled to the memory and the processor configured to:
generate route blocking information based on detection of a blocking state of a communication route of the plurality of communication routes;
generate detour route information set for a destination storage control device of the plurality of storage control devices, which becomes a communication destination, based on the route blocking information;
store the route blocking information and the detour route information in the memory; and
perform a detour communication through a detour route selected based on the detour route information when performing communication to the destination storage control device so as to control the storage device.

2. The storage system according to claim 1,
wherein the processor is configured to, when the route blocking information stored in the memory is updated, transmit the updated route blocking information to the destination storage control device via the communication route which is able to communicate, and
wherein the processor of the destination storage control device is configured to receive the route blocking information transmitted from the first storage control device and update the route blocking information stored in the memory of the second storage control device.

3. The storage system according to claim 2,
wherein the processor is configured to:
update the detour route information stored in the memory according to an update of the route blocking information, and
set, when a plurality of detour destinations exists in the detour route information, a priority for a detour destination of the plurality of detour destinations.

4. The storage system according to claim 3,
wherein the processor is configured to set, when the detour communication is performed, the priority of the detour destination in which a data transfer process of a communication protocol is unnecessary to be higher than the priority of the detour destination in which the data transfer process is necessary.

5. The storage system according to claim 3,
wherein the processor is configured to set, when the detour communication is performed, the priority of the detour destination according to a number of data transfer processes of the communication protocol.

6. The storage system according to claim 3,
wherein the processor is configured to set, when the detour communication is performed, the priority of the detour destination according to a communication limit.

7. The storage system according to claim 6,
wherein the processor is configured to detect, as the communication limit, at least one of an exhaustion state of a memory capacity within a storage control device of the plurality of storage control devices positioned on the detour route and a communication load state.

8. The storage system according to claim 6,
wherein the processor is configured to:
generate communication limit information by detecting the communication limit, and
transmit, when the communication limit information stored in the memory is updated, the communication limit information to the destination storage control device via the communication route which is able to communicate, and
wherein the processor of the destination storage control device is configured to receive the communication limit information transmitted from the first storage control device and update the communication limit information stored in the memory of the second storage control device.

9. The storage system according to claim 1,
wherein the plurality of storage control devices include the first storage control device, a second storage control device, a third storage control device, and a fourth storage control device,
wherein the first storage control device and the second storage control device are included in a first server, and the third storage control device and the fourth storage control device are included in a second server,
wherein the first server couples with the second server through first to fourth communication routes having a first communication protocol, the first storage control device and the second storage control device in the first server are coupled through a fifth communication route having a second communication protocol different from the first communication protocol, and the third storage control device and the fourth storage control device in the second server are coupled through a sixth communication route having the second communication protocol,
wherein the first storage control device is coupled to the third storage control device via the first communication route and coupled to the fourth storage control device via the second communication route,
wherein the second storage control device is coupled to the third storage control device via the third communication route and coupled to the fourth storage control device via the fourth communication route,
wherein the first storage control device and the second storage control device are coupled through the fifth communication route,
wherein the third storage control device and the fourth storage control device are coupled through the sixth communication route, and
wherein the processor of the first storage control device is configured to, when blocking of the first communication route is detected, generate detour route information in which the fourth storage control device is set as a first detour destination and the second storage control device is set as a second detour destination, as a detour destination of data transmission of the first communication protocol having the third storage control device as a reception destination.

10. The storage system according to claim 9,
wherein the processor of the first storage control device is configured to perform a detour communication by selecting the first detour destination to transmit data which is the first communication protocol to the fourth storage control device, rather than the second detour destination to convert data of the first communication protocol into the second communication protocol and transmit the second communication protocol to the second storage control device.

11. The storage system according to claim 9,
wherein the first communication protocol is InfiniBand and the second communication protocol is PCI.

12. The storage system according to claim 9,
Wherein the processor of the first storage control device is configured to, when at least one of an exhaustion state of the memory of the fourth storage control device and that a processor processing load of the fourth storage control device exceeds a threshold value is detected, perform the detour communication by selecting the second detour destination that converts data of the first communication protocol into the second communication protocol and transmitting the second communication protocol to the second storage control device, rather than selecting the first detour destination that transmits data to the fourth storage control device capable of transmitting data with the first communication protocol.

13. A storage control device comprising:
a memory; and
a processor coupled to the memory and the processor configured to:
generate route blocking information based on detection of a blocking state of a communication route;
generate detour route information set for a destination storage control device which becomes a communication destination, based on the route blocking information;
store the route blocking information and the detour route information in the memory; and
perform a detour communication through a detour route selected based on the detour route information when performing communication to the destination storage control device so as to control the storage device.

14. A computer-readable non-transitory recording medium storing a program that causes a computer to execute a procedure, the procedure comprising:
generating route blocking information based on detection of a blocking state of a communication route;
generating detour route information set for a destination storage control device which becomes a communication destination, based on the route blocking information;
storing the route blocking information and the detour route information in the memory; and
performing a detour communication through a detour route selected based on the detour route information when performing communication to the destination storage control device so as to control the storage device.
